(19) United States
(12) Patent Application Publication
(10) Pub. No.: US 2023/0042826 A1
(43) Pub. Date: Feb. 9, 2023

(54) METHOD FOR COORDINATING VEHICLES OF A VEHICLE COMBINATION, AND CONTROL UNIT

(71) Applicant: ZF CV Systems Europe BV, Brussels (BE)

(72) Inventor: Richard Matthaei, Hameln (DE)

(21) Appl. No.: 17/781,384

(22) PCT Filed: Dec. 1, 2020
(86) PCT No.: PCT/EP2020/084041

§ 371 Date: Jun. 1, 2022

(30) Foreign Application Priority Data
Dec. 4, 2019 (DE) 10 2019 132 944.2

(51) Int. Cl. G08G 1/00; B60W 30/16

(52) U.S. Cl. CPC G08G 1/22; B60W 30/16; B60W 2520/10; B60W 2520/105; B60W 2554/802; B60W 2554/4041; B60W 2710/18; B60W 2720/106

(57) ABSTRACT

A method for coordinating vehicles of a vehicle group, including implementing a setpoint acceleration in each vehicle of a vehicle group by electric control of a drive system or of a braking system of the respective vehicle, observing actual driving dynamics of the vehicles of the vehicle group during the implementation of the setpoint acceleration, assessing the observed actual driving dynamics of the vehicles on the basis of the requested setpoint acceleration for the respective vehicle, and outputting a vehicle-specific assessment result, and determining and outputting an acceleration limit value or a jerk limit value as a function of the vehicle-specific assessment result and adapting the vehicle-specific acceleration parameters in at least one of the vehicles of the vehicle group as a function of the determined acceleration limit value or jerk limit value in order to implement the setpoint acceleration.

### CROSS REFERENCE TO RELATED APPLICATIONS

This application is a U.S. National Phase application under 35 U.S.C. § 371 of International Application No. PCT/EP2020/084041, filed on Dec. 1, 2020, and claims benefit to German Patent Application No. DE 10 2019 132 944.2, filed on Dec. 4, 2019. The International Application was published in German on Jun. 10, 2021 as WO 2021/110638 A1 under PCT Article 21(2).

### FIELD

The invention relates to a method for coordinating vehicles of a vehicle group, in particular with the aim of avoiding accidents within the vehicle group in the limit range of the driving dynamics, and to a control unit for carrying out the method.

BACKGROUND It is known that a plurality of vehicles can move one behind the other in a manner coordinated with one another on a roadway at short actual following distances in order to save fuel by reduced drag and/or to reduce steering times by automation of the function. Vehicles coordinated in this way are also referred to as a vehicle group, vehicle convoy or platoon. In the case of such coordinated driving, the intention is to go below the nowadays customary safety distance between the individual vehicles if the vehicles coordinate with one another, for example via wireless V2X communication. In this case, the individual vehicles of the vehicle group are coordinated, for example, by a lead vehicle, which can communicate with the other vehicles via the wireless V2X communication and can exchange data, in particular driving-dynamics data for or from the respective vehicles. Furthermore, it is also possible for information about the environment, including the surrounding road users which do not belong to the vehicle group, to be exchanged.

In this case, the lead vehicle can, in particular, define a specific setpoint following distance and also a central acceleration request and can communicate via the V2X communication, wherein the individual vehicles of the vehicle group set or implement the setpoint following distance, e.g. via a headway control system, and the central acceleration request as a setpoint acceleration via the drive system and/or the braking system. This makes it possible to ensure that the individual vehicles of the vehicle group can react quickly to one another, thereby avoiding an impairment of safety and thus making it possible to go below the safety distance since the reaction times are shortened. It is also possible for the following vehicles of the vehicle group (in particular for the case of decentralized vehicle group coordination) to define their setpoint following distances and setpoint accelerations themselves on the basis of available driving-dynamics data and, in the process, also to access additional information, which is provided in data signals via the V2X communication.

As a result, it is normally possible to coordinate the vehicle group and to operate the individual vehicles in any desired positive or negative acceleration situation in such a way that, if at all possible, the vehicles within a vehicle group do not collide with one another. For this purpose, the acceleration of the individual vehicles within the vehicle group can additionally be mutually coordinated in such a way that the setpoint acceleration of the individual vehicles is limited to a maximum acceleration. Here, the maximum acceleration depends on the vehicle having the lowest driving capacity or the lowest braking capacity within the vehicle group. This ensures that the vehicles in front of the vehicle with the lowest braking capacity do not decelerate faster, or the vehicles behind the vehicle with the lowest driving capacity do not accelerate positively more quickly, and a collision is thereby avoided. However, the problem is that it is often not known within the vehicle group how high the maximum driving capacity or the maximum braking capacity of the individual vehicles is and how fast this can be achieved.

### SUMMARY

In an embodiment, the present disclosure provides a method for coordinating vehicles of a vehicle group, wherein the vehicles each have an electronically controllable drive system or an electronically controllable braking system for implementing a requested setpoint acceleration, taking into account a setpoint jerk, and wherein a position in the vehicle group is assigned to each vehicle, the method comprising implementing the setpoint acceleration in each vehicle of the vehicle group by electric control of the drive system or of the braking system of the respective vehicle, taking into account the setpoint jerk and specified vehicle-specific acceleration parameters, wherein the acceleration parameters define how the requested setpoint acceleration is implemented, observing actual driving dynamics of the vehicles of the vehicle group during the implementation of the setpoint acceleration, taking into account the setpoint jerk and the vehicle-specific acceleration parameters, assessing the observed actual driving dynamics of the vehicles on the basis of the requested setpoint acceleration for the respective vehicle, taking into account the setpoint jerk and the vehicle-specific acceleration parameters, and outputting a vehicle-specific assessment result, and determining and outputting an acceleration limit value or a jerk limit value as a function of the vehicle-specific assessment result and adapting the vehicle-specific acceleration parameters in at least one of the vehicles of the vehicle group as a function of the determined acceleration limit value or jerk limit value in order to implement the setpoint acceleration, taking into account the adapted vehicle-specific acceleration parameters.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a vehicle group comprising three vehicles;

FIG. 2 shows a time profile of the driving dynamics of the vehicles in the vehicle group according to FIG. 1; and

FIG. 3 shows a flow diagram of an embodiment of a method according to the invention.

### DETAILED DESCRIPTION

In an embodiment of the invention, a method is specified for coordinating vehicles of a vehicle group by means of which safe driving operation within the vehicle group can be ensured right into the dynamic limit range when accelerating (positively or negatively) the individual vehicles. A control unit and a vehicle are also specified.

Accordingly, in an embodiment according to the invention, a method is provided for coordinating vehicles of a vehicle group, wherein the vehicles each have an electronically controllable drive system and/or an electronically controllable braking system for implementing a requested setpoint acceleration, which may be either positive or negative, taking into account a setpoint jerk or a setpoint acceleration gradient, and a position in the vehicle group is assigned to each vehicle. At a minimum, the following steps are carried out:
implementing the setpoint acceleration in each vehicle of the vehicle group by electric control of the drive system and of the braking system of the respective vehicle, taking into account the setpoint jerk and specified vehicle-specific acceleration parameters, wherein the acceleration parameters define how the requested setpoint acceleration is to be implemented;
preferably continuously observing (monitoring) actual driving dynamics, preferably of all the vehicles of the vehicle group, during the implementation of the setpoint acceleration, taking into account the setpoint jerk and the vehicle-specific acceleration parameters;
assessing the observed actual driving dynamics of the vehicles with reference to or on the basis of the requested setpoint acceleration for the respective vehicle, taking into account the setpoint jerk and the vehicle-specific acceleration parameters, preferably for all the vehicles, and outputting a vehicle-specific assessment result;
determining and outputting an acceleration limit value and/or a jerk limit value as a function of the vehicle-specific assessment result and adapting the vehicle-specific acceleration parameters in at least one of the vehicles of the vehicle group as a function of the determined acceleration limit value and/or the jerk limit value in order to subsequently implement the setpoint acceleration, taking into account the setpoint jerk and the vehicle-specific acceleration parameters, which are adapted for at least some of the vehicles of the vehicle group.

In this context, the term vehicle-specific is understood to mean that a parameter set of acceleration parameters or an assessment result is assigned to each vehicle. This advantageously ensures that a check is made individually for each vehicle as to whether it is capable of implementing the requested setpoint acceleration, taking into account the setpoint jerk. For this purpose, the maximum braking capacity and/or the maximum driving capacity of the respective vehicle is taken into account by observation and assessment in situ, and therefore this does not necessarily have to be determined in advance, while safe driving operation can nevertheless be ensured. On the other hand, in the event of a change in the vehicle group, for example, an already available parameter set of acceleration parameters can be used as initialization. By means of the acceleration parameters, it is furthermore possible to define in a vehicle-specific manner how the driving dynamics of the respective vehicle are to be adapted in the direction of the requested setpoint acceleration in order to avoid the vehicles driving into one another during observation and assessment.

Thus, the method according to an embodiment of the invention makes it possible, particularly in driving-dynamics limit situations or in emergency situations, to avoid follow-on accidents in the vehicle group and, at the same time, also to brake the vehicle group as quickly as possible.

Here, provision is preferably made for the assessment of the observed actual driving dynamics to include a comparison of the actual driving dynamics with setpoint driving dynamics for the respective vehicle in order to determine whether the respective vehicle is capable of achieving the setpoint driving dynamics, wherein the setpoint driving dynamics are preferably indicated by the setpoint acceleration, taking into account the acceleration parameters. In this way, there is the possibility of a simple in situ setpoint-actual comparison, from which it is possible to deduce directly whether the respective vehicle is capable of implementing the setpoint acceleration.

According to an embodiment, provision is furthermore made for a starting acceleration for defining an initial intermediate acceleration of the respective vehicle during the implementation of the setpoint acceleration and/or a starting acceleration gradient or a starting jerk for adapting the intermediate acceleration in the direction of the requested setpoint acceleration to be specified as the vehicle-specific acceleration parameter in order to implement the requested setpoint acceleration, taking into account the acceleration parameters. In this way, the respective vehicles can advantageously be prescribed starting driving dynamics which each vehicle is preferably capable of performing with a high degree of probability. On this basis, with the starting acceleration gradient or the starting jerk as the setpoint acceleration gradient or setpoint jerk, it is possible to define in a vehicle-specific manner how the respective vehicle is to be accelerated in order to achieve the setpoint acceleration, thus making it is possible to continuously check for each vehicle whether the maximum driving capacity or braking capacity has been achieved.

According to an embodiment, provision is made for a maximum acceleration and/or a maximum jerk to be defined as the acceleration parameter in order to limit a currently requested intermediate acceleration or the setpoint jerk when implementing the requested setpoint acceleration, taking into account the vehicle-specific acceleration parameters. Accordingly, the respective vehicles can be prescribed a limitation, which can be specified or adapted for optimum coordination of the entire vehicle group, for example as a function of the maximum driving capacity and/or of the maximum braking capacity of one of the vehicles in the vehicle group. Preferably, this maximum acceleration or this maximum jerk is defined in such a way that it corresponds to the maximum driving capacity or braking capacity of the vehicle with the poorest (positive) acceleration or braking. This is advantageously characterized by the acceleration and/or jerk limit values determined in the method according to an embodiment of the invention, thus enabling the maximum acceleration or the maximum jerk preferably to be defined and/or adapted as a function thereof.

Here, provision can preferably be made for the maximum acceleration to be adapted as a function of the determined acceleration limit value and/or for the maximum jerk to be adapted as a function of the determined jerk limit value only for those vehicles of the vehicle group which, when a positive setpoint acceleration is specified, are traveling behind the vehicle assigned to the acceleration limit value and/or the jerk limit value, and when a negative setpoint acceleration is specified, are traveling ahead of the vehicle assigned to the acceleration limit value and/or the jerk limit value. As a result, the acceleration or jerk is advantageously limited only for those vehicles in the vehicle group which without the limitation would collide with one of the vehicles in the vehicle group.

Furthermore, provision is preferably made for the setpoint jerk, which can correspond to the starting jerk at the beginning, of the respective vehicle to be defined as a function of the position of the vehicle within the vehicle group and of the acceleration parameters determined according to an embodiment of the invention. This ensures that not every vehicle has to be driven or braked to the same extent starting from the starting acceleration. As a result, the vehicles can advantageously be driven or braked with different driving dynamics from one another during the observation and assessment phase, and thus, with appropriate true-to-position selection of the setpoint jerk, the vehicles can be prevented from running into one another.

For this purpose, provision is preferably made for the setpoint jerk of the respective vehicle to decrease as the position within the vehicle group rises, wherein the position of the first vehicle of the vehicle group is lower than the position of the last vehicle of the vehicle group. Accordingly, it is advantageously achieved that, in the case of a positive setpoint acceleration, the first vehicle, starting from the starting acceleration, is accelerated on a steeper ramp in the direction of the positive setpoint acceleration, and the following vehicles are accelerated more slowly, with the result that, during the assessment of the actual driving dynamics, the following vehicles cannot run into the first vehicle on account of their less steep ramps. This applies successively to all the other vehicles in a similar way.

Correspondingly, in the event of a requested negative setpoint acceleration or braking of the vehicles, a starting jerk of lower value is set for the last vehicle, this corresponding to a ramp which is steeper in terms of its magnitude and thus to a greater change in the deceleration (negative acceleration) in the direction of the negative setpoint acceleration. Thus, the last vehicle with the higher position is braked with the setpoint jerk which is the smallest (or largest in terms of magnitude), thus ensuring that it cannot run into the vehicles traveling ahead, which are braked with a setpointjerk which is larger (or smaller in terms of magnitude). This applies successively to all the other vehicles in a similar way.

Preferably, provision is additionally or alternatively made for a time at which the intermediate acceleration of a vehicle is adapted in the direction of the requested setpoint acceleration with the setpoint jerk, which can correspond to the starting jerk at the beginning, is defined as a function of the position of the vehicle within the vehicle group, wherein, as the position within the vehicle group rises, a later time is selected when a positive setpoint acceleration is specified, and an earlier time is selected when a negative setpoint acceleration is specified. It is thereby possible to have the auxiliary effect that the vehicles are driven or braked with different driving dynamics during the observation and assessment phase in order to avoid adjacent vehicles running into each other.

Furthermore, provision is preferably made for the observation of the actual driving dynamics to include the observation of the following variables with respect to time:
an actual vehicle speed of the respective vehicle, and/or
an actual acceleration of the respective vehicle and/or
an actual jerk of the respective vehicle, taking into account a response time, and/or
an actual distance between two vehicles of the vehicle group, and/or
an actual distance change, i.e. a gradient of the actual distance between two vehicles of the vehicle group.

Here, the response time indicates how quickly the braking system or the drive system of the respective vehicle reacts to an acceleration request, this being dependent, for example, on a time for pressure buildup, etc.

This makes it easy to determine whether or not the respective vehicle can achieve the setpoint acceleration with the setpoint jerk, taking into account the acceleration parameters.

The assessment of the actual distance or the actual distance change is advantageous particularly in slip situations, i.e. in the case of a braking intervention or a drive intervention, since the measurement or estimation of the actual vehicle speed or of the actual acceleration under the influence of slip (brake slip, drive slip) is subject to errors and can therefore only be of indirect use to the actual safety objective of collision avoidance. The actual distance and the actual distance change, on the other hand, are directly related to a potential risk of collision and can therefore be useful for the safety objective in slip situations too. The actual vehicle speed or the actual acceleration can nevertheless preferably be used for plausibility checking and/or outside of strong braking interventions or drive interventions.

For this purpose, provision is advantageously made for the vehicle-specific assessment result with regard to the question of whether the respective vehicle changes its actual driving dynamics in accordance with the acceleration parameters to be formed according to the following criteria:
the actual vehicle speed of the respective vehicle remains constant, and/or
the actual acceleration of the respective vehicle remains constant or decreases in magnitude within a specified time resulting from the dead time and the setpointjerk, and/or
the actual distance between two vehicles remains constant, and/or
the actual distance change is less than or equal to zero, i.e. the actual distance decreases.

Provision is furthermore preferably made for the setpoint acceleration and/or the acceleration parameters for the respective vehicle to be defined in a decentralized manner in the respective vehicles, as a function of data signals transmitted wirelessly between the vehicles, or centrally in one of the vehicles. The method can thus be used in a vehicle group which coordinates itself centrally, for example starting from a lead vehicle, or uses decentralized coordination, in which the respective vehicles themselves define and adapt their driving dynamics as a function of exchanged data signals.

According to an embodiment, provision is furthermore made for the setpoint acceleration and/or the setpoint jerk for the respective vehicle to be specified in an automated manner or manually, in particular as a function of a central acceleration request, for example a central emergency braking request (maximum speed reduction of the vehicle group without an internal collision). With the method according to an embodiment of the invention, it is thus possible to achieve uniform acceleration distribution over the entire vehicle group in the case of a centrally specified braking request, as a result of which, particularly in the case of an emergency braking request, follow-on accidents in the vehicle group can be avoided and, at the same time, the fastest possible braking of the vehicle group in a dangerous situation can be ensured.

However, this is not limited only to an emergency braking request. In other driving-dynamic limit situations or emergency situations too, the method described can ensure that follow-on accidents in the vehicle group are avoided and, at the same time, that the vehicle group is braked as quickly as possible.

Provision is furthermore preferably made, during the implementation of the setpoint acceleration with the setpoint jerk, taking into account the vehicle-specific acceleration parameters, for a check to be made to determine whether the actual distance between the individual vehicles of the vehicle group falls below a specified setpoint distance for the respective vehicles. Accordingly, headway control can be superimposed on the method in order, in addition to the optimized setting of the setpoint acceleration, to avoid vehicles running into each other in case of need and thus to make the method more reliable.

According to an embodiment of the invention, a control unit is also provided for a vehicle which is located in a vehicle group, in which control unit it is possible, in particular, for the method according to an embodiment of the invention to be carried out, wherein the control unit is designed
to implement the setpoint acceleration in the respective vehicle of the vehicle group by electric control of the drive system and of the braking system of the respective vehicle, taking into account a setpoint jerk or a setpoint acceleration gradient and specified vehicle-specific acceleration parameters, wherein the acceleration parameters define how the requested setpoint acceleration is to be implemented;
to observe actual driving dynamics of the respective vehicle of the vehicle group during the implementation of the setpoint acceleration, taking into account the setpoint jerk and the vehicle-specific acceleration parameters;
to assess the observed actual driving dynamics of the respective vehicle on the basis of the requested setpoint acceleration for the respective vehicle, taking into account the setpoint jerk and the vehicle-specific acceleration parameters, and to output a vehicle-specific assessment result;
to determine and output an acceleration limit value and/or a jerk limit value as a function of the vehicle-specific assessment result in order to adapt the vehicle-specific acceleration parameters in at least one of the vehicles of the vehicle group as a function of the determined acceleration limit value and/or jerk limit value.

In this case, the actual driving dynamics are preferably observed by means of sensors, in that the actual vehicle speed of the respective vehicle and/or the actual acceleration of the respective vehicle and/or the actual distance between two vehicles of the vehicle group and/or the actual distance change, i.e. a gradient of the actual distance between two vehicles of the vehicle group, are/is detected continuously by the control unit on the basis of sensor data from corresponding sensors.

The control unit is furthermore preferably designed to transmit and/or receive a data signal transmitted between the vehicles of the vehicle group via wireless data communication and to transfer the determined acceleration limit value and/or jerk limit value to the other vehicles of the vehicle group via the data signal and/or to receive an acceleration limit value and/or jerk limit value assigned to another vehicle and to adapt the acceleration parameters as a function thereof.

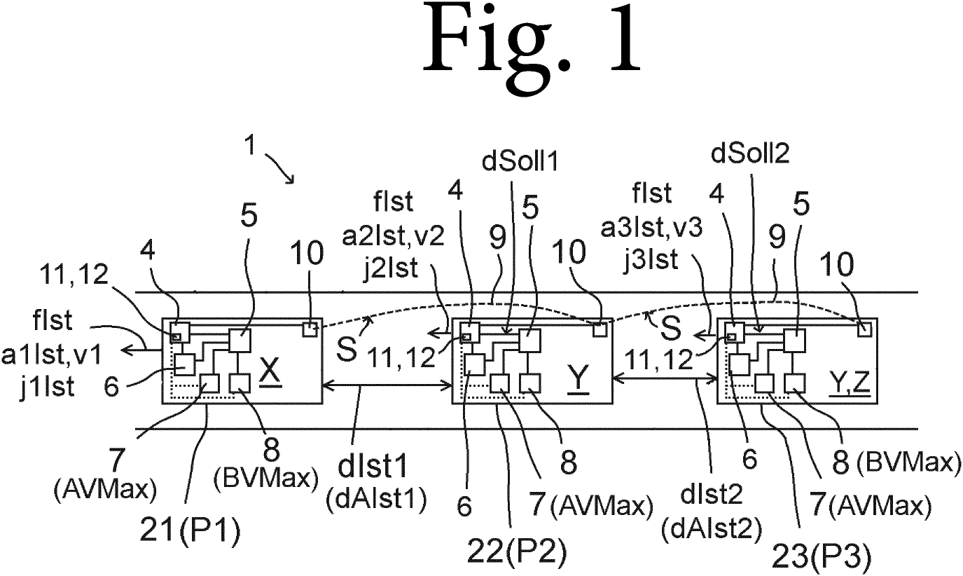

FIG. 1 illustrates a vehicle group 1 or platoon of three vehicles 2i, where i = 1, 2, 3, which move at a specific actual following distance dIstj, where j = 1, 2, with respect to one another. The first vehicle 21 of the vehicle group 1 is referred to as the lead vehicle X, while the second vehicle 22 and the third vehicle 23 are following vehicles Y of the vehicle group 100. The third vehicle 23, as the last vehicle of the vehicle group 1, is referred to as the tail vehicle Z.

The actual following distances dIstj are set in such a way during normal driving operation of the vehicle group 1 that they fall below the safety distance between the individual vehicles 2i which is customary nowadays. This can be justified by the fact that the individual vehicles 2i communicate with one another by wireless data communication 9, in particular V2X communication, and thereby coordinate their driving with one another. In the context of an embodiment of the invention, V2X communication (vehicle-to-everything) refers to a wireless communication facility which allows the individual vehicles 2i to provide and receive data signals S via a specific interface or in accordance with a specific protocol in order to coordinate themselves. In this case, the data signals S contain, for example, information or data relating to driving-dynamic properties of the individual vehicles 2i and/or relevant information or data relating to the vehicle group 1.

For this purpose, in each of the vehicles 2i there is arranged a V2X unit 10 which, in a conventional manner, has a transmitting and receiving module, via which the data signals S can be transmitted and received. Depending on the exchanged data signals S, the driving dynamics of the individual vehicles 2i in the vehicle group 1 can subsequently be adapted. For this purpose, for example, a setpoint acceleration aiSoll is specified as a function of the data signals S and implemented in the respective vehicle 2i. Here, the setpoint acceleration aiSoll can be positive or negative, i.e. an increase or a reduction of the current actual vehicle speed vi of the respective vehicle 2i can be brought about as a function of the data signal S. In this case, the setpoint acceleration aiSoll is implemented in the respective vehicle 2i taking into account a setpoint jerk jiSoll, i.e. a gradient of the setpoint acceleration aiSoll.

In the exemplary embodiment shown, each vehicle 2i has a headway control system 5, which is designed to detect the actual following distance dIstj that is currently present as a function of data from an internal environment detection system 6 and to adjust it to a specified setpoint following distance dSollj, this being relevant only for the following vehicles 22, 23 (Y) in the vehicle group 1 shown. For this purpose, the headway control system 5 is connected in a signal-conducting manner to an electrically controllable drive system 7 and an electrically controllable braking system 8 in order to be able to accelerate or decelerate the respective vehicle 2i in a positive manner and thus set the specified setpoint following distance dSollj.

In normal operation of the vehicle group 1, the setpoint following distance dSollj is specified by means of a control unit 4 in the respective vehicle 2i. The control unit 4 is connected in a signal-conducting manner to the V2X unit 10 or is integrated therein and can therefore access the information and data from the data signal S. As a function of the data signal S, the setpoint following distance dSollj which is matched to the current driving situation of the vehicle group 1, is specified by the control unit 4. The setpoint following distance dSollj can, for example, be determined or defined centrally and transmitted to the individual vehicles 2i of the vehicle group 1 in the data signal S via the wireless data communication 9. The control unit 4 then merely forwards the setpoint following distance dSollj within the vehicle 2i. However, the control unit 4 can also derive the setpoint following distance dSollj itself (in a decentralized manner) for its own vehicle 2i on the basis of the information and data transmitted via the data signal S.

The setpoint following distance dSollj is then transmitted from the control unit 4 to the headway control system 5. The headway control system 5 then generates a setpoint acceleration aiSoll as a function of the determined setpoint following distance dSollj and of the actual following distance dIstj which is currently present, which setpoint acceleration aiSoll is correspondingly implemented via the drive system 7 or the braking system 8 of the respective vehicle 2i with a specific setpoint jerk jiSoll. The setpoint acceleration aiSoll is thus determined in the headway control system 5 as a function of the data signal S or the information and data contained therein.

In this context, it is not only possible for a setpoint acceleration aiSoll for the respective vehicle 2i to be specified by the headway control system 5. On the contrary, it is also possible for the setpoint acceleration aiSoll to be defined or output directly by the control unit 4 and/or by further driver assistance systems 11 in the respective vehicle 2i, which then control the drive system 7 or the braking system 8 electrically, indirectly or directly, as a function thereof in order to implement the setpoint acceleration aiSoll in the vehicle 2i. It is also possible for a centrally defined setpoint acceleration aiSoll to be transmitted to the respective vehicle 2i via the wireless data communication 9 and output by the control unit 4 directly or indirectly, for example via the headway control system 5, to the drive system 7 or the braking system 8.

By way of example, when a dangerous situation is detected, for example by a predictive emergency braking system 12 (AEBS, Advanced Emergency Braking System), one of the vehicles 2i of the vehicle group 1 can generate an emergency braking request zNSoll for implementation in all the vehicles 2i of the vehicle group 1. This emergency braking request zNSoll is transmitted as a (negative) setpoint acceleration aiSoll via the wireless data communication 9 to the individual vehicles 2i of the vehicle group 1 and is received therein by the respective control unit 4 and transmitted to the braking system 8 for implementation. However, the setpoint acceleration aiSoll can also be specified in some other automated way, the method according to an embodiment of the invention distinguishing itself particularly in instances of braking specification in driving-dynamics limit situations since it is thereby possible to ensure avoidance of follow-on accidents in the vehicle group 1 and, at the same time, the fastest possible braking of the vehicle group 1.

However, the setpoint acceleration aiSoll can also be specified manually by the driver, for example by actuating an actuating element when a dangerous situation or the like is detected, and can be implemented by means of the control unit 4 and communicated simultaneously to the other vehicles 2i of the vehicle group 1.

According to an embodiment of the invention, the control unit 4 is furthermore designed to define vehicle-specific acceleration parameters Bi, with which the drive system 7 and/or the braking system 8 of the respective vehicle 2i implements an arbitrarily specified setpoint acceleration aiSoll during a journey in the vehicle group 1, taking into account the setpoint jerk jiSoll. In this case, the acceleration parameters Bi are preferably used in the implementation of any setpoint accelerations aiSoll (headway control system 5, control unit 4, driver assistance system 11, predictive emergency braking system 12 (zNSoll)), this being accomplished, for example, by means of corresponding transmission of the acceleration parameters Bi to the electronically controllable drive system 7 or braking system 8.

As acceleration parameters Bi, a starting acceleration aiStart and/or a maximum acceleration aiMax and/or a starting jerk jiStart and/or a maximum jerk jiMax, for example, can be specified in a vehicle-specific way. If a specific setpoint acceleration aiSoll is requested, the respective vehicle 2i is first accelerated positively or negatively with an intermediate acceleration aiZ, which is defined by the specified starting acceleration aiStart. The starting acceleration aiStart is normally smaller in terms of magnitude than the setpoint acceleration aiSoll and has a value which any vehicle 2i is normally able to deliver.

Starting from this, the starting jerk jiStart indicates how the magnitude of the intermediate acceleration aiZ should be increased over time, starting from the starting acceleration aiStart, in order to approximate the intermediate acceleration aiZ to the requested setpoint acceleration aiSoll. In this way, the starting jerk jiStart is initially defined as the setpoint jerkjiSoll.

The maximum acceleration aiMax indicates an additional limit which the magnitude of the intermediate acceleration aiZ must not exceed. Under certain circumstances, the maximum acceleration aiMax may be smaller in magnitude than the requested setpoint acceleration aiSoll. The maximum jerk jiMax furthermore indicates a limit of the setpoint jerk jiSoll which must not be exceeded in terms of magnitude. The maximum acceleration aiMax and/or the maximum jerk jiMax can follow, for example, from the maximum driving capacity AVMax or the maximum braking capacity BVMax which can be provided by the drive system 7 or the braking system 8 of the respective vehicle 2i. However, the maximum acceleration aiMax and/or the maximum jerk jiMax can also be specified for the control unit 4 of the respective vehicle 2i, for example via the V2X unit 10.

The starting acceleration aiStart and the starting jerk jiStart can also be specified to the control unit 4 by the V2X unit 10, whereupon the control unit 4 defines these in its own vehicle 2i in order to implement an existing setpoint acceleration aiSoll with the setpoint jerk aiSoll.

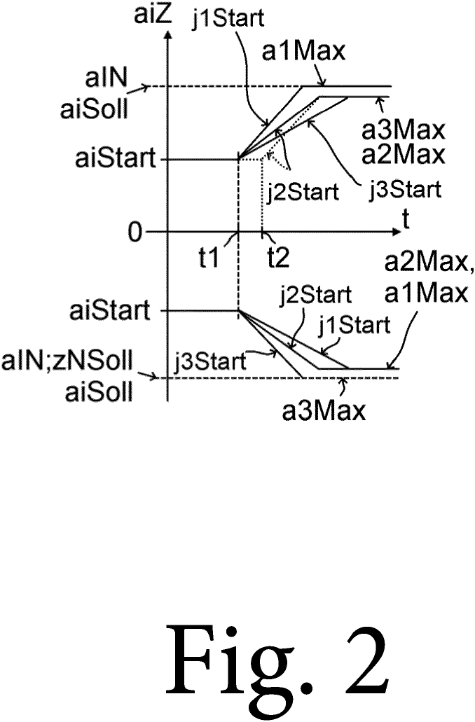

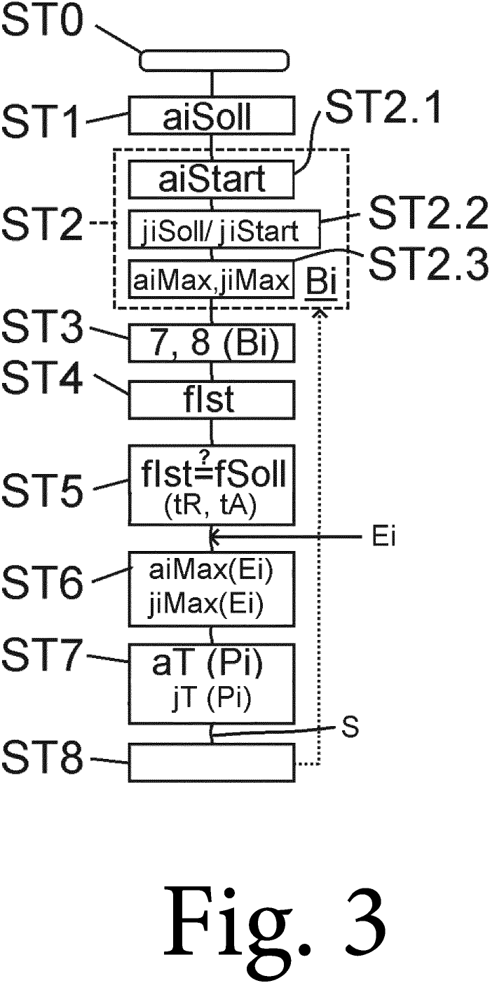

The definition of vehicle-specific acceleration parameters Bi allows selective coordination of the vehicles 2i of the vehicle group 1, this being explained in greater detail below with reference to FIGS. 2 and 3:

After initialization of the control units 4 in the vehicles 2i of the vehicle group 1 in an initial step ST0 (FIG. 3), for example when starting the vehicle 2i or when entering a vehicle group 1, an arbitrarily requested setpoint acceleration aiSoll for the respective vehicle 2i is detected or read in in a first step ST1.

In order to accelerate the entire vehicle group 1 safely in accordance with the setpoint acceleration aiSoll, positively or negatively, and to optimally coordinate the individual vehicles 2i with one another during this process within the scope of their performance capability, the vehicle-specific acceleration parameters Bi for each individual vehicle 2i are defined in a second step ST2. Definition takes place either centrally in one of the vehicles 2i of the vehicle group 1 with subsequent transmission to the individual vehicles 2i via the wireless data communication 9 or at least partially in a decentralized manner in each vehicle 2i separately, data signals S transmitted being taken into account.

In a first intermediate step ST2.1, a suitable starting acceleration aiStart, which it is assumed will be provided by each of the vehicles 2i of the vehicle group 1, is specified for this purpose. In a second intermediate step ST2.2, the starting jerk jiStart is defined as the setpoint jerk jiSoll, each vehicle 2i being assigned an individual starting jerk jiStart as the setpoint jerk jiSoll. In particular, the starting jerk jiStart is defined as a function of a position Pi of the respective vehicle 2i within the vehicle group 1. In a third intermediate step ST2.3, the maximum acceleration aiMax and/or the maximum jerk jiMax is defined for the respective vehicle 2i, for example as a function of the maximum possible driving capacity AVMax or braking capacity BVMax of the respective vehicle 2i. If the maximum acceleration aiMax or the maximum jerk jiMax is not yet known at this time or cannot be determined, it is initially left undefined or fixed to a value of high magnitude, for example to the currently specified setpoint acceleration aiSoll.

As illustrated in FIG. 2, the definition of the starting jerk jiStart as the setpoint jerk jiSoll takes place as a function of the position Pi of the respective vehicle 2i within the vehicle group 1 in such a way that the starting gradient jiStart
decreases with rising position Pi in the case of a positive setpoint acceleration aiSoll, and
increases in magnitude (i.e. also decreases) with rising position Pi in the case of negative setpoint acceleration aiSoll.

Accordingly, the first intermediate acceleration a1Z of the first vehicle 1 at the first position P1 of the vehicle group 1 is increased in magnitude along a steeper ramp (jiStart) than the third intermediate acceleration a3Z of the third vehicle 3 at the third position P3 of the vehicle group 1 when there is a requested increase in the actual vehicle speed vi (aiSoll positive) vehicle group 1. Correspondingly, the third intermediate acceleration a3Z of the third vehicle 3 at the third position P3 is increased in magnitude along a steeper ramp (jiStart) than the first intermediate acceleration a1Z of the first vehicle 1 at the first position P1 when there is a requested reduction in the actual vehicle speed vi (aiSoll negative).

This is based on the concept according to an embodiment of the invention of accelerating or decelerating a vehicle 2i traveling further to the rear within the vehicle group 1 in a less strongly positive manner or in a less strongly negative manner than a vehicle 2i traveling further to the front in order to prevent a collision of the vehicles 2i in the respective driving situation. This is achieved precisely by virtue of the fact that, starting from the starting acceleration aiStart, the vehicle 2i traveling further to the rear increases or reduces its intermediate acceleration aiZ less strongly than the vehicle or vehicles 2i traveling in front of it.

According to the exemplary embodiment shown in FIG. 2, starting from the starting acceleration aiStart, the intermediate acceleration aiZ is increased or reduced for all the vehicles 2i at a first time t1 with different values for the starting jerk jiStart. As an alternative or in addition to such a definition of different values for the starting jerk jiStart as a function of the position Pi of the respective vehicle 2i, it is also possible for the times t at which, starting from the starting acceleration aiStart with the respective starting jerk ji Start, the respective vehicle 2i adapts its intermediate acceleration aiZ to vary as a function of the position Pi. Accordingly, at the first time t1, only the intermediate acceleration a1Z, a3Z for the first vehicle 21 (if aiSoll is positive) or the third vehicle 23 (if aiSoll is negative) may be adapted with a specific starting jerk j1Start, j3Start. At a subsequent second time t2, the intermediate acceleration a2Z for the second vehicle 22 is then adapted, adaptation taking place with the same starting jerk j2Start (dotted in FIG. 2) as for the first vehicle 21. This too ensures that vehicles 2i of the vehicle group 1 which are traveling one behind the other are braked continuously with different intermediate accelerations aiZ and thus cannot run into one another. Preferably, however, the selection of different starting jerks jiStart as a function of the position Pi and a simultaneous (t1) increase in the intermediate acceleration aiZ is provided for each vehicle 2i in order to shorten the period of time to achieve the requested setpoint acceleration aiSoll for the entire vehicle group 1, this being decisive particularly in emergency braking situations and other driving-dynamics limit situations.

In a third step ST3, the previously defined acceleration parameters Bi are used directly or indirectly to implement the setpoint acceleration aiSoll specified in the first step ST1, taking into account the setpoint jerk jiSoll, via the drive system 7 or the braking system 8 of the respective vehicle 2i. Rules are thus imposed on the respective vehicle 2i as to how it must implement a specified setpoint acceleration aiSoll.

In a fourth step ST4, the driving-dynamics behavior (actual driving dynamics fIst) of the vehicles 2i of the vehicle group 1 is observed during implementation of the setpoint acceleration aiSoll using the acceleration parameters Bi and taking into account the setpoint jerk jiSoll. This can be accomplished, for example, in that an actual acceleration aiIst present and/or the actual vehicle speed vi and/or an actual jerk jiIst of the respective vehicle 2i are/is determined. This observation can take place in a decentralized manner in each of the vehicles 2i or else centrally in one of the vehicles 2i in that the actual acceleration aiIst and/or the actual vehicle speed vi is transmitted wirelessly between the vehicles 2i in a time-resolved manner via the data signals S.

Alternatively, it is also possible to consider the actual distance dIstj between the individual vehicles 2i and/or an actual distance change dAIstj in a time-resolved manner in order to observe the actual driving dynamics fIst of a vehicle 2i. Accordingly, it can be determined, for example by means of sensors, how quickly two vehicles 2i are approaching one another or moving further apart.

In a fifth step ST5, the observed actual driving dynamics fIst (aiIst, vi, dIstj, dAIstj, jiIst) are compared with setpoint driving dynamics fSoll, wherein the setpoint driving dynamics fSoll are indicated by the setpoint acceleration aiSoll, taking into account the setpoint jerk jiSoll and the acceleration parameters Bi. Depending on this comparison, a vehicle-specific assessment result Ei is output, which indicates whether the respective vehicle 2i is capable of adapting the intermediate acceleration aiZ, taking into account the setpoint jerk jiSoll and the acceleration parameters Bi, and of achieving the setpoint acceleration aiSoll in this way.

If, for a vehicle 2i of the vehicle group 1, it is determined, for example, that
the actual acceleration aiIst does not increase further in magnitude and at the same time the setpoint acceleration aiSoll has not yet been reached, or
the actual acceleration aiIst decreases in magnitude within a specified period of time tR, wherein the specified period of time (tR) is dependent on the setpoint jerk (jiSoll), taking into account a response time tA, or
the actual distance dIstj does not behave in accordance with the specified setpoint driving dynamics fSoll of the two vehicles 2i driving at the actual distance dIstj, or the actual distance change dAIstj does not correspond to the expected behavior (decrease or increase),
an assessment result Ei is output for the respective vehicle 2i, which indicates whether the respective vehicle 2i is not capable of adapting the intermediate acceleration aiZ, taking into account the setpoint jerk jiSoll and the acceleration parameters Bi, and of achieving the setpoint acceleration aiSoll in this way.

Thereupon, in a sixth step ST6, the currently present actual acceleration aiIst is defined as the maximum acceleration aiMax and/or the present actual jerk jiIst is defined as the maximum jerk jiMax for the respective vehicle 2i. The value assumed temporarily in the third intermediate step 2.3 for the maximum acceleration aiMax and/or the maximum jerk jiMax is thereby confirmed, overwritten or supplemented. This maximum acceleration aiMax or this maximum jerk jiMax is then transmitted in a seventh step ST7 as an acceleration limit value aT or jerk limit value jT, via the data signal S, to the other vehicles 2i of the vehicle group 1. In this case, the respective vehicle 2i or its position Pi can also be assigned to the acceleration limit value aT or the jerk limit value jT in the data signal S.

In an eighth step ST8, the transmitted acceleration limit value aT or the jerk limit value jT is used as the acceleration parameter Bi or as the maximum acceleration aiMax or maximum jerk jiMax for the other vehicles 2i of the vehicle group 1. Thus, the maximum accelerations aiMax or maximum jerks jiMax of all the vehicles 2i of the vehicle group 1 are uniformly set to the previously determined acceleration limit value aT or jerk limit value jT. Alternatively, provision can also be made for the transmitted acceleration limit value aT or jerk limit value jT to be used as the maximum acceleration aiMax or maximum jerk jiMax only in the case of the vehicles 2i which
are traveling behind the vehicle 2i assigned to the acceleration limit value aT or jerk limit value jT in the case of a positive setpoint acceleration aiSoll, and
are traveling ahead of the vehicle 2i assigned to the acceleration limit value aT or jerk limit value jT in the case of a negative setpoint acceleration aiSoll. For this purpose, it is possible to take into account the position Pi of the respective vehicle 2i which is associated with the acceleration limit value aT or jerk limit value jT.

In this way, it is possible, when adapting the respective intermediate acceleration aiZ in accordance with the setpoint jerk jiSoll, to determine successively for each vehicle 2i which maximum acceleration aiMax or which maximum jerk jiMax is relevant and whether the driving dynamics of the further vehicles 2i of the vehicle group 1 must be adapted thereto in order to avoid the vehicles 2i running into one another in the respective driving situation.

This is illustrated by way of example in FIG. 2. According to this, in a braking situation, the requested setpoint acceleration aiSoll is achieved for the third vehicle 3 at the third position P3 of the vehicle group 1, wherein the maximum acceleration aiMax for the third vehicle 3 either corresponds to the setpoint acceleration aiSoll or this acceleration has not yet been achieved. For the second vehicle 2, the intermediate acceleration aiZ reaches the second maximum acceleration a2Max from a specific time, for example because the maximum braking capacity BVMax for the second vehicle 2 has been reached. In this case, the second maximum acceleration a2Max is lower than the requested setpoint acceleration a2Soll. This also has effects on the first vehicle 1 at the first position P1, which accordingly also has to be braked at the maximum with the second maximum acceleration a2Max to avoid the second vehicle 2 running into the first vehicle 1. Accordingly, the second maximum acceleration a2Max is transmitted as an acceleration limit value aT assigned to the second vehicle 2 (second position P2) via the wireless data communication, in particular to the first vehicle 1. In this vehicle, the acceleration limit value aT is used as one of the acceleration parameters B1 to define the first maximum acceleration a1Max, and therefore the first vehicle 1 too brakes at the maximum with the first or second maximum acceleration a1Max (= a2Max) to implement the requested setpoint acceleration a1Soll. Since the implemented acceleration of the first vehicle 1 follows the implemented acceleration of the second vehicle 2 in time during the braking process, it is possible, by means of real-time transmission of the second maximum acceleration a2Max of the second vehicle 2 which has just been determined, to ensure that the first vehicle 1 reacts to the limitation of the second vehicle 2 which has just been achieved, that is to say a2Max, while the braking process is still taking place. It is by just such means that improved accident prevention within the vehicle group 1 can be achieved.

In a comparable manner, this applies to the case of a (positive) acceleration situation, which is likewise shown in FIG. 2. A corresponding situation applies when a specific jerk limit value jT is determined, which is transmitted to the respective vehicles 2i, with the result that the driving behavior thereof in positive or negative acceleration situations is thereby defined.

With the method according to an embodiment of the invention, it is therefore possible to accomplish optimized and uniform definition of the maximum accelerations aiMax and/or of the maximum jerks jiMax over the entire vehicle group 1, thus making it possible to avoid the individual vehicles 2i within the vehicle group 1 running into one another in the respective driving situation. In the case of a (positive) acceleration situation, this may be the case in particular if no headway control is present or active and the individual vehicles 2i could accordingly run into one another in the presence of a positive setpoint acceleration aiSoll if these vehicles adapt their actual speed vi independently of one another with their respective, possibly unknown, maximum driving capacity AVMax.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE DESIGNATIONS (PART OF THE DESCRIPTION

1 vehicle group (platoon)

2i i-th vehicle of the vehicle group

4 control unit

5 headway control system

6 internal environment detection system

7 drive system

8 braking system

9 wireless data communication (V2X)

10 V2X unit

11 driver assistance system

12 predictive emergency braking system (AEBS)

aiIst actual acceleration

aiMax maximum acceleration

aiSoll setpoint acceleration

aiStart starting acceleration

aiZ intermediate acceleration

aINcentral acceleration request

aT acceleration limit value

AVMax maximum driving capacity

Bi vehicle-specific acceleration parameters

BVMax maximum braking capacity

dIstj actual following distance

dAIstj actual following distance change

dSollj setpoint following distance

Ei assessment result

fIst actual driving dynamics

fSoll setpoint driving dynamics

jiIst actual jerk

jiMax maximum jerk

jiSoll setpoint jerk

jiStart starting jerk

jiT jerk limit value

Pi position of the i-th vehicle 2i in the vehicle group 1

zNSoll emergency braking request

S data signal

t, t1, t2 times

tA response time

vi actual vehicle speed

X lead vehicle

Y following vehicle

Z tail vehicle

ST0, ST1, ST2, ST2.1, ST2.2, ST2.3, ST3, ST4, ST5, ST6, ST7, ST8

1. A method for coordinating vehicles-(3i) of a vehicle group, wherein the vehicles-(3i) each have an electronically controllable drive system or an electronically controllable braking system for implementing a requested setpoint acceleration, taking into account a setpoint jerk and wherein a position in the vehicle group is assigned to each vehicle (2i), the method comprising:
implementing the setpoint acceleration in each vehicle of the vehicle group by electric control of the drive system or of the braking system of the respective vehicle, taking into account the setpoint jerk and specified vehicle-specific acceleration parameters, wherein the acceleration parameters define how the requested setpoint acceleration is implemented;
observing actual driving dynamics of the vehicles of the vehicle group during the implementation of the setpoint acceleration taking into account the setpoint jerk and the vehicle-specific acceleration parameters;
assessing the observed actual driving dynamics of the vehicles-(3i) on the basis of the requested setpoint acceleration for the respective vehicle (2i), taking into account the setpoint jerk and the vehicle-specific acceleration parameters, and outputting a vehicle-specific assessment result; and
determining and outputting an acceleration limit value or a jerk limit value as a function of the vehicle-specific assessment result and adapting the vehicle-specific acceleration parameters in at least one of the vehicles-(3i) of the vehicle group as a function of the determined acceleration limit value or jerk limit value in order to implement the setpoint acceleration taking into account the adapted vehicle-specific acceleration parameters.

2. The method as claimed in claim 1, wherein the assessing the observed actual driving dynamics includes comparing the actual driving dynamics with setpoint driving dynamics for the respective vehicle in order to determine whether the respective vehicle is capable of achieving the setpoint driving dynamics, wherein the setpoint driving dynamics are indicated by the setpoint acceleration, taking into account the setpoint jerk and the acceleration parameters.

3. The method as claimed in claim 1 or 2, characterized in that wherein a starting acceleration for defining an initial intermediate acceleration of the respective vehicle during the implementation of the setpoint acceleration ora starting jerk for adapting the intermediate acceleration in the direction of the requested setpoint acceleration is specified as the vehicle-specific acceleration parameter in order to implement the requested setpoint acceleration, taking into account the acceleration parameters.

4. The method as claimed in claim 1 , wherein a maximum acceleration or a maximum jerkis defined as the acceleration parameter for limiting a currently requested intermediate acceleration or the setpoint jerk when implementing the requested setpoint acceleration, taking into account the vehicle-specific acceleration parameters.

5. The method as claimed in claim 4, wherein the maximum acceleration (aiMax) or the maximum jerk is adapted as a function of the determined acceleration limit value or the jerk limit value.

6. The method as claimed in claim 5, wherein the maximum acceleration is adapted as a function of the determined acceleration limit value, or the maximum jerk is adapted as a function of the determined jerk limit value, only for vehicles of the vehicle group which:
are traveling behind the vehicle assigned to the acceleration limit value or the jerk limit value when a positive setpoint acceleration is specified, and
are traveling ahead of the vehicle assigned to the acceleration limit value or the jerk limit value when a negative setpoint acceleration is specified.

7. The method as claimed in claim , wherein the maximum acceleration or the maximum jerk of a vehicle is defined or adapted as a function of a maximum driving capacity or of a maximum braking capacity of one of the vehicles in the vehicle group.

8. The method as claimed in claim 3 , wherein the setpoint jerk or the starting jerk of the respective vehicle is defined as a function of the position of the vehicle within the vehicle group.

9. The method as claimed in claim 8, wherein the setpoint jerk or the starting jerk of the respective vehicle decreases as the position within the vehicle group rises, and wherein the position of a first vehicle of the vehicle group is lower than the position of a last vehicle of the vehicle group.

10. The method as claimed in claim 3 wherein a time at which the intermediate acceleration of a vehicle is adapted with the setpoint jerk or the starting jerk-in the direction of the requested setpoint acceleration is defined as a function of the position of the vehicle within the vehicle group, and wherein, as the position within the vehicle group rises,
a later time is selected if a positive setpoint acceleration is specified, and
an earlier time is selected if a negative setpoint acceleration is specified.

11. The method as claimed claim 1 , wherein observing the actual driving dynamics includes observing with respect to time an actual vehicle speed of the respective vehicle or an actual acceleration of the respective vehicle or an actual jerk of the respective vehicle, taking into account a response time or an actual distance between two vehicles of the vehicle group or an actual distance change of the actual distance between two vehicles of the vehicle group.

12. The method as claimed in claim 11, wherein the vehicle-specific assessment result is formed as a function of whether
the actual vehicle speed of the respective vehicle remains constant, or
-the actual acceleration of the respective vehicle remains constant or decreases in magnitude within a specified period of time, wherein the specified period of time is dependent on the setpointjerk, taking into account the response time, or
the actual distance between two vehicles remains constant, or
the actual distance change is less than or equal to zero.

13. The method as claimed in claim 1 , wherein the setpoint acceleration or the setpoint jerk or the vehicle-specific acceleration parameters for the respective vehicle is/are defined in a decentralized manner in the respective vehicles , as a function of data signals transmitted wirelessly between the vehicles, or centrally in one of the vehicles.

14. The method as claimed in claim 13, wherein the setpoint jerk or the vehicle-specific acceleration parameters for the respective vehicle are adopted as initial values from previous joumeys in a vehicle group.

15. The method as claimed in claim 1 , wherein the setpoint acceleration or the setpoint jerk for the respective vehicle is specified in an automated manner or manually, as a function of a central emergency braking request of an emergency braking system.

16. The method as claimed in claim , comprising checking, during the implementation of the setpoint acceleration taking into account the setpoint jerk and the vehicle-specific acceleration parameters, to determine whether the actual distance between individual vehicles of the vehicle group falls below a specified setpoint distance for the respective vehicles.

17. A control unit for a vehicle, which is located in a vehicle group, for carrying out a method as claimed in claim 1 , wherein the control unit is configured to:
implement the setpoint acceleration in the respective vehicle of the vehicle group by electric control of the drive system or of the braking system of the respective vehicle (2i), taking into account a setpoint jerk and specified vehicle-specific acceleration parameters, wherein the acceleration parameters define how the requested setpoint acceleration is to be implemented;
observe actual driving dynamics of the respective vehicle of the vehicle group during the implementation of the setpoint acceleration, taking into account the setpoint jerk and the vehicle-specific acceleration parameters;
assess the observed actual driving dynamics of the respective vehicle on the basis of the requested setpoint acceleration for the respective vehicle (2i), taking into account the setpoint jerk and the vehicle-specific acceleration parameters, and to output a vehicle-specific assessment result;and
determine and output an acceleration limit value or a jerk limit value as a function of the vehicle-specific assessment result in order to adapt the vehicle-specific acceleration parameters in at least one of the vehicles of the vehicle group as a function of the determined acceleration limit value or jerk limit value.

18. The control unit as claimed in claim 17, wherein the control unit is configured to transmit or receive a data signal transmitted between vehicles of the vehicle group via wireless data communication and to transfer the determined acceleration limit value or jerk limit value to the other vehicles of the vehicle group via the data signal or to receive an acceleration limit value or jerk limit value assigned to another vehicle and to adapt the acceleration parameters as a function thereof.

19. A vehicle having a control unit as claimed in claim 17 .
